(19) United States
(12) Patent Application Publication
(10) Pub. No.: US 2004/0074722 A1
(43) Pub. Date: Apr. 22, 2004

(54) Method for filling hydraulic apparatus with liquid, and apparatus thus filled

(76) Inventors: Philippe Queval, (US); Bernard Moirand, (US)

Correspondence Address: Leo H. McCormick Jr/, 2112 Mishawaka Avenue, P.O. Box 4721, South Bend, IN, 46634, US

(21) Appl. No.: 10/664,130

(22) Filed: Sep. 17, 2003

(30) Foreign Application Priority Data
Sep. 11, 2002 (FR) 02/11278

(51) Int. Cl. B60T 11/00

(52) U.S. Cl. 188/352

(57) ABSTRACT

A method for filling with liquid a hydraulic apparatus (1), with a circuit (4), comprising an air bleed orifice (5) allowing the apparatus and the circuit to be bled manually. The conventional feed screw in the bleed orifice (5) is replaced with a solid set screw (9). For filling, enough vacuum is pulled in the apparatus (1) and the circuit (4) by drawing air through a withdrawing orifice (R), and the apparatus is filled with liquid from the withdrawing orifice.

This invention relates to a method for filling with liquid a hydraulic apparatus in a circuit, comprising an air bleed orifice that allows the apparatus and the circuit to be manually bled.

The invention relates more particularly, although not exclusively, to a method for filling a vehicle braking hydraulic receiver, for example a drum brake wheel cylinder or a disk brake caliper, and to the associated hydraulic circuit.

The bleed orifice is equipped, in the usual way, with a bleed screw comprising an axial duct opening to the outside. Such a bleed screw is bulky and impedes intervention with tools near the hydraulic tapping that provides the connection to the receiver. Furthermore, this bleed screw with an axial duct is relatively expensive.

It is an object of the invention, above all, to provide a filling method that dispenses with a bulky and costly bleed screw.

According to the invention, the method for filling with liquid a hydraulic apparatus, with a circuit, comprising an air bleed orifice, is characterized in that the bleed orifice is sealed closed by a solid set screw, in that sufficient vacuum is pulled in the apparatus and in the circuit by drawing air through a withdrawing orifice, and in that the apparatus is filled with liquid from the same withdrawing orifice.

The solid set screw that closes the bleed orifice allows a reduction in the bulk around the hydraulic tapping and a reduction in the cost price by comparison with a bleed screw with an axial duct. If, subsequently, during a repair or maintenance operation, the apparatus, having been emptied, needs to be refilled with liquid under conditions requiring a manual bleed, this bleed can be done through the air bleed orifice by partially or completely unscrewing the solid set screw.

Advantageously, the set screw is a hexagon socket cap head screw of small bulk.

Provision may be made for the set screw, when tightened, to be fully housed in its accommodating hole such that the screw does not protrude beyond the visible contour of the hydraulic apparatus on which it is installed.

When the hydraulic receiver consists of a drum brake wheel cylinder, the set screw, when tightened, may protrude from the accommodating hole by just enough distance to collaborate with a plate supporting the cylinder and participate in preventing the cylinder from rotating relative to the plate.

When a repair or maintenance operation is carried out, for example in a garage, on a motor vehicle hydraulic circuit, the set screw may be replaced with a hollow bleed screw for filling and bleeding the apparatus and the hydraulic circuit. The bleed screw can then be left in place or, as an alternative, the solid set screw may be refitted after the filling and bleeding operation.

The invention also relates to hydraulic apparatus comprising an air bleed orifice, filled with liquid, this apparatus being characterized in that the air bleed orifice is plugged by a solid set screw.

The hydraulic apparatus may consist of a vehicle drum brake wheel cylinder or of a disk brake caliper.

In the case of a drum brake wheel cylinder, the set screw, when tightened, may protrude from the accommodating hole by just enough distance to collaborate with the plate supporting the cylinder, without, however, filling the space around the tapping.

The set screw is advantageously a hexagon socket cap head screw. The set screw may be placed symmetrically with respect to the screw that attaches the wheel cylinder.

The hydraulic receiver, particularly a drum brake wheel cylinder, may comprise an additional discharge orifice that can be opened by partial unscrewing of the set screw for a manual bleed operation.

Apart from the provisions set out hereinabove, the invention consists in a certain number of other provisions that will be explained more fully hereinbelow with regard to some exemplary embodiments described with reference to the drawings attached hereto, but which are not in any way limiting.

In these drawings:

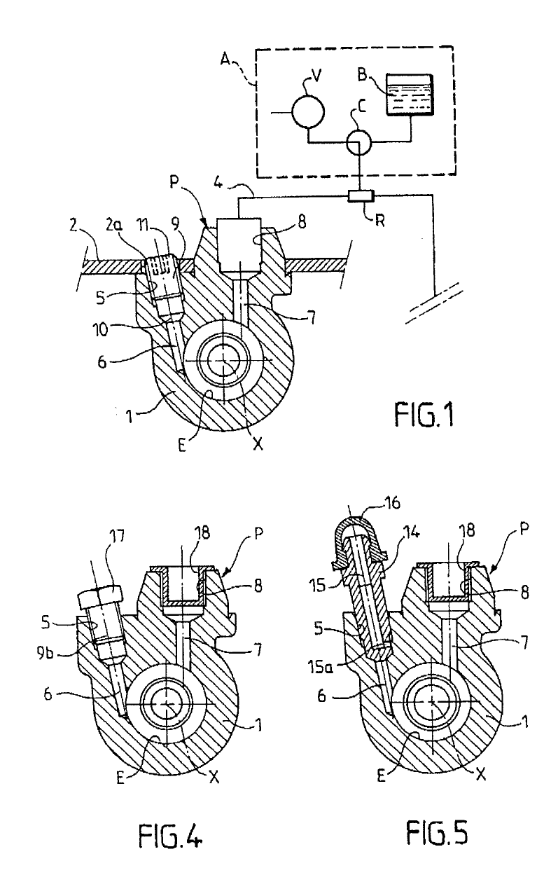

FIG. 1 is a diagram illustrating the method, according to the invention, for filling with liquid a drum brake wheel cylinder, with associated hydraulic circuit;

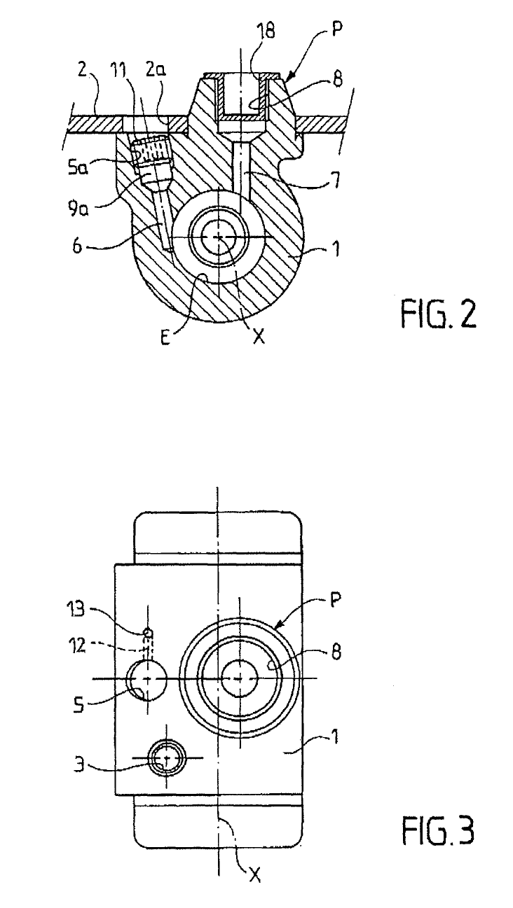

FIG. 2 shows, in vertical cross section, an alternative form of embodiment of the wheel cylinder and of the set screw that closes the bleed orifice;

FIG. 3 is a view on FIG. 2 from above, of the wheel cylinder, without the fixing plate;

FIG. 4 shows, in a similar way to FIG. 2, an alternative form of embodiment; and

FIG. 5, finally, shows, in a way similar to FIG. 2, the wheel cylinder temporarily or permanently equipped with a bleed screw for a manual bleed operation.

FIG. 1 shows a hydraulic receiver consisting of a motor vehicle drum brake wheel cylinder 1 held on a plate 2 by a screw (not depicted) collaborating with a tapped hole 3 (FIG. 3) of the cylinder body. The cylinder 1 forms part of the hydraulic braking circuit 4, briefly depicted, of the motor vehicle.

A bleed orifice 5 is provided in the body of the wheel cylinder 1 and opens to the outside. This orifice communicates via a duct 6 with the bore E of the cylinder 1. This bore E communicates with another duct 7 connected to an orifice 8 for connection to the circuit 4.

The bleed orifice 5 is tapped over part of its length from its opening to the outside. This bleed orifice 5 is sealed closed by a solid set screw 9. The interior end of this screw consists of a frustoconical point collaborating with a corresponding seat made at the end of the duct 6 opening toward the orifice 5. The screw 9 has a hexagon socket cap head 11 allowing the screw to be turned using an appropriate key. The radial bulk of the screw head is minimal.

The axial length of the screw 9, as illustrated in the example of FIG. 1, is such that when the screw is tightened, the screw protrudes out of the accommodating hole 5 by just enough distance to collaborate with the edge of a through hole 2a made in the plate 2. The screw 9 thus contributes to preventing the rotation, relative to the plate 2, of the cylinder 1 that is generally held in place by just one screw collaborating with the hole 3 (FIG. 3).

The tapped hole 5 and the screw 9 may be arranged symmetrically to the orifice 3 with respect to the plane orthogonal to the geometric axis X of the cylinder 1 and equidistant from its ends.

The circuit 4 is connected by a connector R to a vacuum filling installation A depicted schematically. The installation A comprises a vacuum source V, for example a vacuum pump, and a reservoir B of liquid under pressure. The vacuum source V and the reservoir B are connected respectively to a valve C which, for a position depicted in FIG. 1, allows the connector R and the circuit 4 to be connected to the vacuum source V and, for another position, allows the connector R to be connected to the reservoir B and the vacuum source V to be isolated.

To fill the cylinder 1 and the circuit 4 with hydraulic liquid, avoiding the presence of air bubbles, the procedure is as follows.

The circuit 4 is placed in communication with the vacuum source V and enough vacuum is pulled in the circuit by drawing air through the withdrawing orifice consisting of the connector R. When a sufficient vacuum has been pulled, the valve C is operated to connect the circuit 4 to the reservoir B, isolating the vacuum source V. Hydraulic fluid from the reservoir B fills the circuit 4 and the cylinder 1, emptied of air, under a pressure that may be of the order of 2 bar. When filling is over, the connector R is disconnected from the filling installation A, and the withdrawing orifice is closed, preferably automatically.

The hydraulic receiver 1 and the circuit 4 are filled with liquid without the presence of air bubbles and without there being any need to perform bleeding through the orifice 5.

However, this bleed orifice 5 remains available to carry out manual bleeding in the event of a repair or a maintenance operation, for example in a garage that might not be equipped with a vacuum filling installation A.

In order to bleed air in the case of such filling, the set screw 11 may be slackened off so that the air that is to be removed and some liquid leave via the screw thread. It is possible to make an arrangement to duct the liquid by providing a tube that has to be connected to a pipe.

An alternative form of embodiment is illustrated in FIG. 3 where the orifice 5 is depicted without the closure set screw. A lateral duct 12 starts from the lower region of the orifice 5 and opens at the surface of the cylinder body 1 via an orifice 13. Partial slackening off of the set screw 11 allows the lower end of the duct 12 to be opened and air for bleeding and liquid to flow out through the duct 12 and the orifice 13. This orifice 13 can be connected by a tube to removal pipework.

According to another alternative form, manual bleeding may be performed by completely unscrewing the set screw 11 and replacing it with a conventional bleed screw 14 (see FIG. 5) with an axial duct 15. The bleed screw 14 is depicted with its plastic protective cap 16. For the bleed operation, the cap 16 is removed and the upper end of the screw is generally connected to a removal pipe. The screw 14 is slackened off slightly so as to allow air and liquid to escape via the duct 15, the lower end 15a of which opens radially into the orifice 5. Bleeding is continued by exerting pressure on the vehicle brake pedal in order to drive the air out of the hydraulic circuit and cause it to be removed through the bleed screw. When the bleed operation is over, the operator can leave the bleed screw 14 in place, once he has tightened it again, or may replace it with the set screw 9.

A comparison of FIGS. 1 and 5 gives an understanding of the significant reduction in bulk obtained with the solid set screw 9 as compared with a conventional bleed screw 14, around the hydraulic tapping P designed for connection of the cylinder 1. This results in an appreciable reduction in constraints on tools for use in this area, for example for tightening the connector.

According to the alternative form of FIG. 2, the set screw 9a has an even smaller bulk than the screw 9 of FIG. 1 and is fully housed in the bleed orifice 5a when tightened. However, the set screw 9a no longer collaborates with the fixing plate 2 to participate in preventing the cylinder 1 from turning.

FIG. 4 shows an alternative form of embodiment whereby the set screw 9b has a hexagonal head 17. The bulk of the screw is slightly greater than in the case of FIGS. 1 and 2.

In FIGS. 2, 4 and 5, the orifice 8 designed for connecting the cylinder 1 to the hydraulic circuit is depicted equipped with a plastic protective cap 18 which is removed when the cylinder 1 is mounted and connected to the hydraulic circuit.

The solid set screw 9, 9a, 9b used to seal the bleed orifice allows a cost reduction by comparison with the solution that consists in permanently equipping the cylinder 1 with a bleed screw such as 14. This advantage is in addition to the aforementioned reduction in bulk.

The possibility of installing the set screw symmetrically with the screw that attaches the wheel cylinder, which collaborates with the tapped hole 3, allows the environment to be optimized, reducing the volume of material.

As the set screw is solid, there is no longer any problem of deformation as there was with a bleed screw such as 14 at its orifice, during successive tightening/slackening operations.

Although the description has been given with reference to a vehicle drum brake wheel cylinder 1, the solution of the invention may obviously apply to any hydraulic apparatus, of the braking receiver type, which has to be bled by hand. This is the case in particular of a disk brake caliper.

For subsequent manual bleeding performed using a bleed screw 14 (FIG. 5), all that is required is for such a bleed screw to be available as an after-sales item for professionals tasked with repair operations The bleed screw may remain in place after retightening, or may be replaced with the set screw.

We claim:

1. A method for filling with liquid, a hydraulic apparatus (1) with a circuit (4), comprising an air bleed orifice (5) allowing the apparatus and the circuit to be bled manually, characterized in that said bleed orifice (5) is sealed closed by a solid set screw (9, 9a, 9b), in that sufficient vacuum is pulled in the apparatus (1) and in the circuit (4) by drawing air through a withdrawing orifice (R), and in that the apparatus is filled with liquid from the same withdrawing orifice.

2. The method according to claim 1, characterized in that the solid set screw (9, 9a) is a hexagon socket cap head (11) screw.

3. The method according to claim 2, characterized in that, when the solid set screw (9a) is tightened, it is fully housed in its accommodating hole (5) such that the screw (9a) does not protrude beyond the visible contour of the hydraulic apparatus (1) on which it is installed.

4. The method according to claim 2, wherein said hydraulic receiver consisting of a drum brake wheel cylinder (1), characterized in that the set screw (9a), when tightened, protrudes from the accommodating hole (5) by just enough distance to collaborate with a plate (2) supporting the cylinder (1) and participate in preventing the cylinder from rotating relative to the plate (2).

5. A hydraulic apparatus (1) comprising an air bleed orifice (5), filled with liquid, characterized in that the air bleed orifice (5) is plugged by a solid set screw (9, 9a, 9b).

6. The hydraulic apparatus according to claim 5, characterized in that said hydraulic apparatus (1) consists of a vehicle drum brake wheel cylinder.

7. The hydraulic apparatus according to claim 6, characterized in that the set screw (9a), when tightened, protrudes from the accommodating hole (5) by just enough distance to collaborate with a plate (2) supporting said wheel cylinder (1).

8. The hydraulic apparatus according to claim 5, characterized in that said hydraulic apparatus consists of a disk brake caliper.

9. The hydraulic apparatus according to claim 5, characterized in that said solid set screw (9, 9a) is a hexagon socket cap head (11) screw.

10. The hydraulic apparatus according to claim 5 characterized in that said hydraulic apparatus is a drum brake wheel cylinder having an additional discharge orifice (12, 13) that can be opened by partial unscrewing of the set screw for a manual bleed operation.
